(19) United States
(12) Patent Application Publication
(10) Pub. No.: US 2006/0138120 A1
(43) Pub. Date: Jun. 29, 2006

(54) Warming device and methods for warming an article

(76) Inventor: Curtis P. Taylor, Moreland Hills, OH (US)

Correspondence Address: Justin S. Rerko & Associates, LLC, 19836 Ellsworth Drive, Strongsville, OH, 44149, US

(21) Appl. No.: 11/020,231

(22) Filed: Dec. 27, 2004

(51) Int. Cl. H05B 3/06

(52) U.S. Cl. 219/521

(57) ABSTRACT

A warming device, adapted to be positioned on a surface, for supporting and warming a towel. The warming device generally includes a body member comprising a first wall member, a second wall member, an arcuate connecting portion associated with the first wall and the second wall and for maintaining the walls in spaced apart relationship, and an open cavity disposed along a first surface of the first wall member, second wall member and the arcuate connecting portion, and wherein the open cavity is adapted for supporting a towel therein; a resistance heating mat disposed along a second surface of the first wall member, second wall member and the arcuate connecting portion and adapted to heat a towel when supported in the open cavity, wherein the resistance heating mat comprises a first electrically nonconductive layer, a second electrically nonconductive layer, and a resistance heating element disposed between the first and second layers, and wherein the resistance heating element is adapted to dissipate heat responsive to the flow of electric current therethrough. The device preferably also includes at least one surface engaging base member associated with the body member and for maintaining the body member in a desired orientation; and a means adapted for coupling the resistance heating element to a flowable source of electric current.

### FIELD OF THE INVENTION

The present invention is directed to a warming device and methods for warming an article. More particularly, the present invention is directed to a towel rack suspendable device adapted for warming towels and similar articles and to methods for warming towels and similar articles.

### BRIEF DISCUSSION OF THE RELATED ART

Towels and similar articles are frequently employed by individuals for a variety of purposes, most notably including removing water from the surface of an individual's body following, for example, showering, bathing, swimming, using a hot tub, or other bodily contact with water. In particular, individuals typically take a shower in the morning prior to leaving their house. Upon exiting the shower, individuals obtain a towel, typically from a wall mounted towel rack, and vigorously rub the towel over their body to remove water therefrom. Once finished, the towel is typically returned to the towel rack.

An unpleasant complication associated with showering is due to the disparity between the ambient temperature of a bathroom and the temperature of the water used for showering. For example, individuals typically take a shower at a temperature higher than bodily temperature, i.e., over 98 degrees F. However, the ambient temperature of the bathroom into which the individual steps on exiting the shower is typically in the 60 to 70 degrees F. range, vastly lower than that of the shower temperature. Accordingly, individuals experience temperature-based discomfort on passing from the warm shower to the cooler bathroom.

A conventional approach for ameliorating the temperature-based discomfort involves the heating of towels to be used in the bodily drying. A variety of towel warming devices are known, but all suffer from significant disadvantages. For example, many such devices require invasive structural modifications to accommodate the device, leading to undesired expense and cosmetic alteration of a bathroom. By way of additional example, other devices exist that do not require such modification, but otherwise are highly expensive to manufacture and thus commercially available to a limited market segment. Accordingly, what is needed is a warming device that overcomes the limitations of conventional devices.

### BRIEF SUMMARY OF THE INVENTION

In accordance with one example aspect, the present invention is directed to a warming device, adapted to be positioned on a surface, for supporting and warming a towel. The warming device generally includes a body member comprising a towel engaging substrate having a first surface for supporting a towel thereon and a second surface, a support member associated with the towel engaging substrate, and a cavity disposed between the second surface of the towel engaging substrate and the support member; and a resistance heating mat disposed in the body member cavity and adapted to heat a towel when supported on the towel engaging substrate first surface, wherein the resistance heating mat comprises a first electrically nonconductive layer, a second electrically nonconductive layer, and a resistance heating element disposed between the first and second layers, and wherein the resistance heating element is adapted to dissipate heat responsive to the flow of electric current therethrough. The device preferably also includes at least one surface engaging base member associated with the body member and for maintaining the body member in a desired orientation; and a means adapted for coupling the resistance heating element to a flowable source of electric current.

In accordance with another example aspect, the present invention is directed to a warming device, adapted to be positioned on a surface, for supporting and warming a towel. The warming device suitably includes a body member comprising a first wall member, a second wall member, an arcuate connecting portion associated with the first wall and the second wall and for maintaining the walls in spaced apart relationship, and an open cavity disposed along a first surface of the first wall member, second wall member and the arcuate connecting portion, and wherein the open cavity is adapted for supporting a towel therein; and a resistance heating mat disposed along a second surface of the first wall member, second wall member and the arcuate connecting portion and adapted to heat a towel when supported in the open cavity, wherein the resistance heating mat comprises a first electrically nonconductive layer, a second electrically nonconductive layer, and a resistance heating element disposed between the first and second layers, and wherein the resistance heating element is adapted to dissipate heat responsive to the flow of electric current therethrough. The device preferably also includes at least one surface engaging base member associated with the body member and for maintaining the body member in a desired orientation; and means adapted for coupling the resistance heating element to a flowable source of electric current.

In accordance with yet another example aspect, the present invention is directed to a warming device, adapted to be positioned on a surface, for supporting and warming a towel. The warming device preferably includes a body member comprising a first wall member, a second wall member, an arcuate connecting portion associated with the first wall and the second wall and for maintaining the walls in spaced apart relationship, and an open cavity disposed along a first surface of the first wall member, second wall member and the arcuate connecting portion, and wherein the open cavity is adapted for supporting a towel therein; and a resistance heating mat disposed along a second surface of the first wall member, second wall member and the arcuate connecting portion and adapted to heat a towel when supported in the open cavity, wherein the resistance heating mat comprises a first electrically nonconductive layer, a second electrically nonconductive layer, and a resistance heating element disposed between the first and second layers, and wherein the resistance heating element is adapted to dissipate heat responsive to the flow of electric current therethrough. The warming device suitably also includes at least one surface engaging base member associated with the body member and for maintaining the body member in a desired orientation; a means adapted for coupling the resistance heating element to a flowable source of electric current; a means, responsive to user input, for actuating the flow of electric current to the resistance heating mat; and a means, responsive to the means for actuating the flow of electric current, for preventing the flow of electric current to the resistance heating mat upon expiration of a predetermined period of time.

### BRIEF DESCRIPTION OF THE DRAWINGS

These and other features and a more thorough understanding of the present invention may be achieved by referring to the following description and claims, taken in conjunction with the accompanying drawings, wherein:

FIG. 1 is a front perspective view of an example warming device embodiment according to the present invention;

FIG. 2 is a rear perspective view of the example warming device of FIG. 2;

FIG. 3 is an exploded view of components of the example warming device of FIGS. 1 and 2;

FIG. 4 is a bottom view of the example warming device of FIGS. 1-3;

FIG. 5 is a perspective view of an alternate example warming device embodiment according to the present invention, in which an access door is in a closed position;

FIG. 6 is a perspective view of the warming device of FIG. 5, in which the access door is in an open position;

FIG. 7 is an enlarged perspective view of an example access door pivot assembly of the warming device of FIGS. 5 and 6;

FIG. 8 is a partially cut away perspective view of the warming device of FIGS. 5-7, particularly illustrating an example heating element;

FIG. 9 is a plan view of the warming device of FIGS. 5-8, particularly illustrating an example user interface;

FIG. 10 is a perspective view of an additional example warming device embodiment according to the present invention;

FIG. 11 is a perspective exploded view of the example warming device of FIG. 10;

FIG. 12 is a perspective cut away view of the example warming device of FIGS. 10 and 11;

FIG. 13 is a perspective enlarged view of an example fastener assembly of the example warming device of FIGS. 10-12;

FIG. 14 is a perspective view of the example warming device of FIGS. 10-13 suspended from a wall-mounted towel rack and having a towel associated therewith; and

FIG. 15 is a perspective view of the example warming device of FIGS. 10-14 arranged in an example tandem array of two interconnected warming devices.

### DETAILED DISCUSSION OF EXAMPLE EMBODIMENTS

Disclosed according to the present invention are a warming device, a plurality of embodiments thereof and methods for warming an article, such as a conventional bath towel. The device and methods are useful for warming any of a plurality of articles, especially textile-based articles; however, reference will be made throughout to a preferred conventional bath towel article. In general, the device and methods of the present invention operate to warm a towel by maintaining a towel in proximity to a heating element, preferably, for example, a resistance heating mat. A towel warmed by the device and methods of the present invention is useful for, e.g., drying a body after exposure to water, such as showering, bathing, swimming, enjoying a hot tub, etc., and for easing the transition from a warm environment to a relatively cooler environment. The device and methods are particularly advantageous due to the simplicity of operation and installation of the devices, low cost for manufacturing and retailing the devices, and small and unobtrusive size profile of the devices.

The present invention provides a warming device, a plurality of example embodiments of the warming device and associated methods, each of which suitably utilizes a resistance heating mat to warm a towel. Each of the embodiments and methods preferably include a configuration of structure that maintains the heating mat in a desired orientation and suitably enables positioning and/or location of the warming device in any of a plurality of desired locations, especially in a conventional bathroom-based location, and more preferably on a bathroom floor, fixedly secured to a bathroom wall, atop a bathroom toilet, atop a bathroom countertop, atop a bathroom shelf, suspendedly engaged with a wall mounted towel rack, and the like. Certain features are preferably common to each of the warming device embodiments and a discussion of the common features will initially follow. Thereafter, a discussion of each of the example embodiments and associated methods will be provided.

A resistance heating mat is a preferred heating source preferably common to each of the example warming device embodiments. The resistance heating mat suitably is the means by which the warming device generates heat and transfers the heat to a towel, thereby warming the same. In more exemplary detail, the heating mat is preferably comprised of a top layer, a bottom layer, and a heating element disposed therebetween. The top layer and bottom layer are preferably substantially flat, thin and rectangular members, being generally mirror images of each other, and constructed of an electrically insulating and durable material. Suitable example materials for the construction of the top and bottom layers include, but are not limited to, vinyl (e.g., Duraflex™, available from Duraflex, Tewkesbury, England), acrylonitrile-budadiene-styrene(ABS) plastic, polyvinylchloride (PVC), polyarylate, polycarbonate, high density polyethylene (HDPE), acrylic-styrene-acrylonitrile (ASA), polystyrene (PS), styrene-acrylonitrile (SAN), polyarylsulfone, and any suitable heat transferable and preferably electrically insulated material.

The heating element of the heating mat is preferably a resistance heating element disposed between and generally sandwiched by the top and bottom layers. The resistance heating element is preferably an elongate heating wire sinuously looped throughout the heating mat in a manner that maximizes the amount of heating wire disposed in the mat, thereby increasing its heat-emitting capacity. The resistance heating element is electrically coupled to control circuitry (as will be more fully described below) and is of any suitable material (such as, for example, an alloy of copper, tin, lead and/or platinum) that operates to dissipate resistance created from a circuit, and thereby generate heat, as known to one of ordinary skill in the art. Example commercially available heating mats include mats available from Calesco, those available under the tradename Performance Master Advantage Plus, and the like.

The heating mat may additionally include a reflective insulation pad and/or layer disposed between the heating element and the bottom layer. An example reflective insulation pad is suitably constructed from a foil-like material, such as aluminum, and operates to direct the radiation of heat from the heating element upward.

An additional feature preferably common to each of the example embodiments is control circuitry. The control circuitry suitably couples the heating mat to a source of electrical current, enables a user to control and/or direct operation of the resistance heating mat, and/or contains elements that provide certain safety features.

The resistance heating mat is preferably couplable to a source of electrical current through a conventional electric cord electrically associated with the heating mat in a well known manner. The electric cord preferably includes at one end a plug adaptor adapted to be connected to a source of electric current, e.g., 120V AC, one or more batteries, etc. The electrical cord is preferably provided in substantial length to facilitate positioning of the towel warming device in any desired position. The electrical cord may suitably be retractable into the body of the towel warming device to simplify storage of the device and to reduce the amount of unneeded cord being exposed from the device. Alternatively, a surface of the device may suitably include one or more projections protruding therefrom adapted for receiving the electric cord wrapped therearound for convenient storage of the electrical cord. Additionally, a spool-like mechanism may be provided for enabling winding of the electric cord around a spool.

Preferably, the warming device includes means adapted for enabling the warming device to electrically couple to other devices. In a preferred embodiment, the device includes an electrical plug adaptor integrated therewith and communicatively coupled to the control circuitry in a manner that the adaptor provides a source of electrical current to a second device associated with the warming device. Provisioning the warming device with means for coupling the warming device to another device suitably enables the operation of a plurality of devices in a room, such as a bathroom, that normally suffers from a lack of wall mounted electrical outlets. It is to be appreciated that the means for electrically coupling the warming device to another device need to be limited to an electrical plug adaptor and may include any structure adapted to complementarily engage with corresponding structure on another device.

The control circuitry suitably also includes elements that enable a user to control and/or direct operation of the heating mat. The control elements generally include one or more means adapted for enabling a user to actuate the flow of electrical current to the heating mat, thereby activating the same to emanate heat. The means may suitably be provided as a user interface adapted to receive user input and translate the received user input into an actuation of the flow of electric current for the heating mat. The user interface may be any appropriate device, such as a conventional on/off switch, a pushbutton switch, a rotary dial, a slidable mechanism, and similar devices adapted to be physically manipulated by a user.

The user interface may suitably be coupled to a means, responsive to the user input, adapted for preventing the flow of electric current to the heating mat after a predetermined period of time. For example, the user interface may be coupled to a timer that is activated in response to the actuation of the user interface and suitably causes electrical current to flow to the heating mat for a predetermined period of time. Upon the expiration of the predetermined period of time, the flow of electrical current to the heating mat is discontinued, thereby eliminating the generation of heat thereby. The predetermined period of time may be an automatic feature built in to the device during construction and/or assembly, according to which activation of the user interface automatically directs operation of the heating mat for the predetermined period of time. Alternatively, the predetermined period of time may suitably be manually inputtable by the user by, for example, a rotary knob-like device adapted to be turned and/or set with reference to one of a plurality of time durations, such as five minutes, ten minutes, thirty minutes, and the like. Any appropriate device may suitably be employed for enabling a user to preselect a duration for heating, such as a rheostat-like slide, and the like.

The user interface may suitably also include a programmable interface adapted for receiving user-generated instructions for operation of the warming device and for automatically executing the heating in accordance with the instructions. Many individuals follow well established routines, such as, for example, always entering the shower at 6:30 AM during workdays. Accordingly, the programmable interface is adapted to be programmed with user generated instructions for automating the actuating of the warming device. With continued reference to the foregoing example, such user generated instructions may direct the towel warming device to activate every Monday through Friday at precisely 6:30 AM, or a time shortly thereafter, and for a predetermined duration, e.g., seven minutes, all selected to coincide with, for example, the individual's typical exit from the shower so that the individual is presented with a warm towel upon the exit. The user programmable mechanism is any conventionally known user programmable mechanism adapted for accomplishing the foregoing aims, such as, for example, a data processing device, and the like.

The user interface may additionally comprise means adapted for providing certain information to the user. For example, the interface may include means adapted for informing the user when the warming device is active and heating a towel. Such means may include, for example, a light emitting diode (“LED”) coupled to the control circuitry and adapted to be illuminated when current is passing to the heating mat. Additionally, the LED may suitably be positioned in proximity to a written indicium, such as a “heating” indicium that enables a user to readily understand the information being conveyed by the LED. Additional information providing means may be provided, such as an LED adapted to inform when the device is in a cool down mode, etc.

Additionally, the user interface may also include a means adapted for receiving user selection of a desired temperature. For example, such a means may be provided as a rotary dial that enables a user to select one of a range of available temperatures for the heat output by the heating mat. Such means may be provided by any well known device and electrically associated with the heating mat in any appropriate manner.

The control circuitry suitably also includes protective elements adapted for governing various aspects of the operation of the heating mat. In connection with the example embodiment in which the user interface comprises a timer-like element, the timer provides certain safety advantages for operation of the warming device. For example, the timer ensures that the device is activated only upon user-generated input into the user interface. By way of additional example, the timer also ensures that the device is activated for only the preselected period of time, thereby protecting against any risks associated with prolonged activation of the device.

With continued reference to protective elements, the control circuitry may additionally comprise a temperature cutoff switch, such as a bimetallic over temperature cutoff switch, having a temperature sensor adapted to sense the temperature of the heating mat and/or the environment of the heating mat. The switch is a conventional switch, preferably responsive to a preselected temperature value and adapted to prevent the flow of current to the heating mat upon attainment of the preselected temperature value. Preventing the flow of current under these conditions suitably prevents overheating and possible damage to the components of the towel, the towel warming device, and the environment of the device. Other components may additionally be associated with the control circuitry, such as ground fault circuit interrupter (GFCI) components, general components adapted for resisting the deleterious impact of water, and the like.

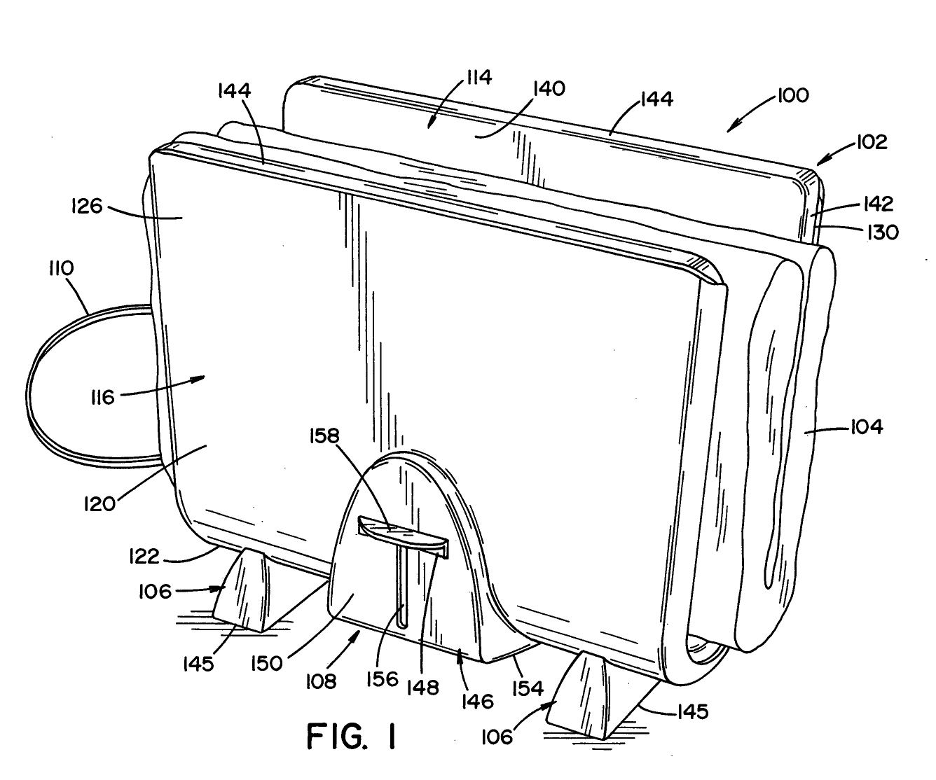

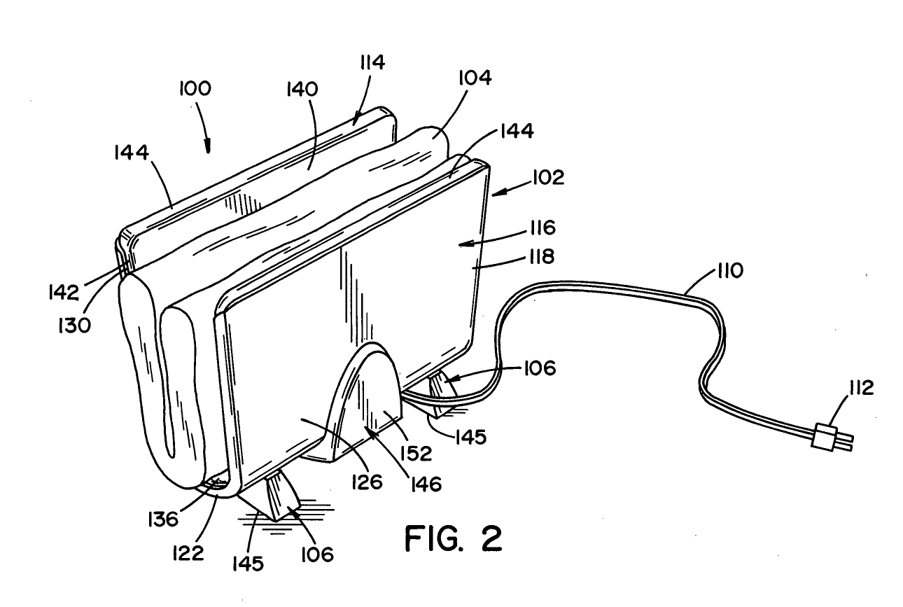

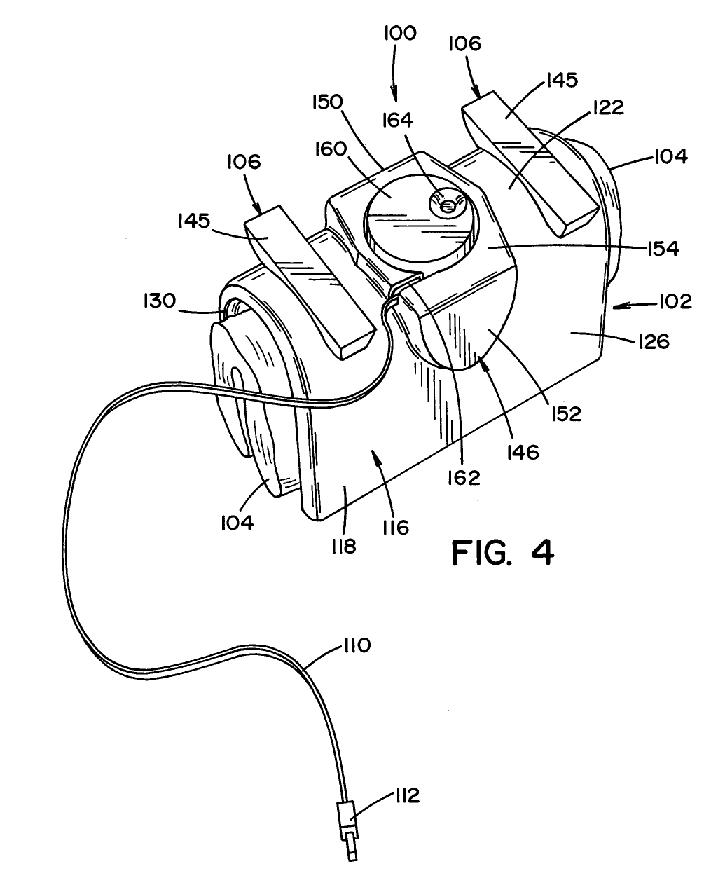

An example first embodiment of a warming device 100 according to the present invention will now be discussed with reference to FIGS. 1-4. The example warming device 100 is preferably disposed in a generally magazine rack-like configuration and is adapted to heat a towel 104 by maintaining the towel in proximity to a heating mat associated with the device 100, as will be more fully described.

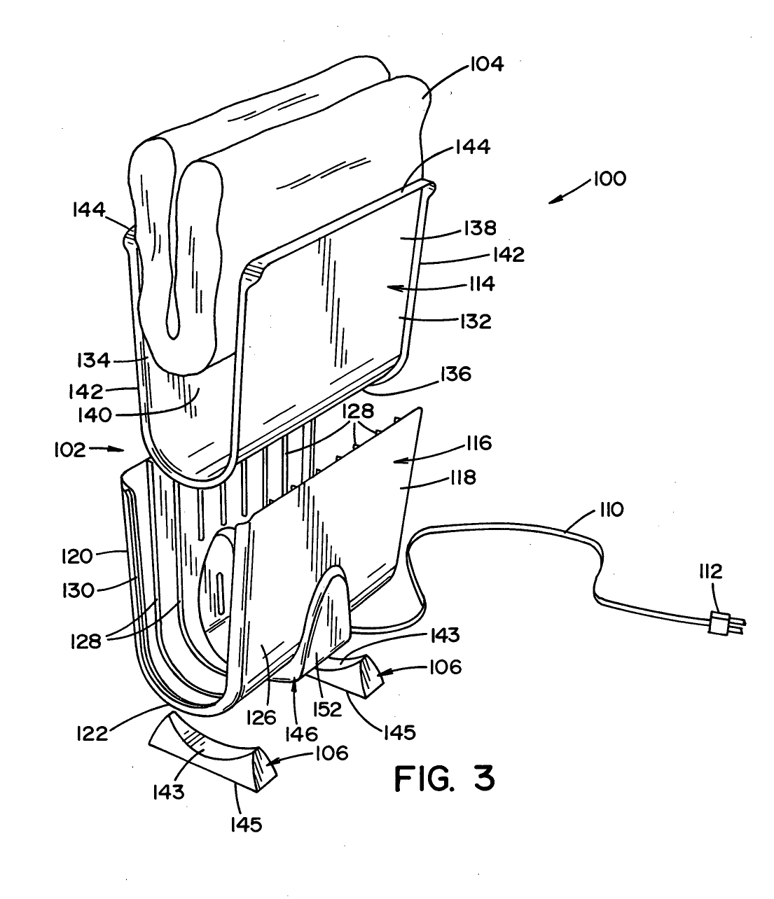

The example towel warming device 100 of FIG. 1 generally includes a support means 102 and a heating mat (not illustrated) associated therewith. In a preferred embodiment, the support means 102 is provided as a generally letter “U” shaped element adapted to receive a towel between its upright vertical portions and be maintained in an upright position by one or more bases 106. With reference to FIG. 3, the support means 102 preferably comprises a substrate support member 116, a towel engaging substrate 114 supported by and associated with the substrate support member 116, and a heating mat disposed between the support member 116 and the towel engaging substrate 114. The towel engaging substrate 114 generally provides a substrate against which the towel 104 is positioned for heating, and which substrate 114 is maintained in an upright position by association with the substrate support member 116. As will be more fully described below, the resistance heating mat is disposed in a cavity defined between the substrate 114 and the support member 116, and accordingly transfers heat to the towel 104 when the towel 104 is maintained along the towel engaging substrate 114.

With continued reference to FIG. 3, the substrate support member 116 is preferably provided in an overall letter “U” shaped configuration and accordingly is defined by a pair of opposed and generally vertical walls 118, 120 preferably maintained in a spaced apart relationship by a connecting portion 122. More preferably, the walls 118, 120 and the connecting portion 122 are a unitary construction, overall further including an outer surface 126 and an inner surface 124. The walls 118, 120 and connecting portion 122 are preferably of any suitable dimensions particularly suited for the accommodation of a towel. More preferably, the walls 118, 120 and connecting portion 122 are characterized by a length slightly shorter than the length of a conventional bath towel, thereby resulting in a portion of the towel 104 being laterally exposed from the device 100 when the towel 104 is associated with the device 100, which exposed portion suitably assists a user in removing the towel 104 therefrom and inserting the towel 104 therein. Further, the walls 118, 120 and connecting portion 122 are preferably constructed from a plastic displaying desired thermal and elastic properties, or any other suitable material, such as metal, alloys, and the like.

The connecting portion 122 is preferably an arcuate and generally semispherical member disposed in a manner that translates its curvature to the walls 118, 120. Preferably, the curvature maintains the walls 118, 120 in spaced apart and slightly angularly offset relationship to each other. Accordingly, bottom portions of the walls 118, 120 (i.e., those portions generally near the connecting portion 122) are generally spaced apart by a distance that is smaller than the distance separating upper portions of the walls 118, 120 (i.e., those portions generally distal to the connecting portion 122). This arrangement suitably facilitates the insertion of a towel 104 into the device 100 by endowing the device 100 with an overall funnel-like, upwardly tapered characteristic.

The connecting portion 122 is preferably constructed from a suitable material, such as an appropriate plastic, that imparts a degree of resilient flexibility, elasticity, and biasing on the portion 122. Preferably, the walls 118, 120 are spaced apart and angularly offset in a appropriate dimensions that causes a towel 104 placed therebetween to be slightly compressed, which compression is effectuated by the arcuate and resiliently flexible nature of the connecting portion 122. Applying a compressive force to the towel 104 suitably increases the transfer of heat to the towel 104 generated by the resistance heating mat.

In a preferred embodiment, the inner surface 124 of the support member 116 contains a plurality of rib-like protrusions 128 extending along substantially the entire surface thereof. The ribs 128 preferably extend vertically along the inner surface 124 of each of the walls 118, 120 and are continuously disposed along the inner surface 124 of the connecting portion 122 as well. The presence of ribs 128 along the support member 116 suitably increases the structural rigidity thereof. Additionally, as will be more fully described below, the heating mat is disposed along the inner surface 124 of the support member 116. Accordingly, the ribs 128 maintain the heating mat in a spaced apart relationship to the support member 116 and reduce the transfer to heat from the mat to the outer surface 126 of the support member 116. The ribs 128 suitably also facilitate the ventilation of air in the space between the mat and the support member 116 inner surface 124, which ventilation may further be facilitated by the presence of a plurality of ventilation apertures fashioned in the support member 116.

With repeated reference to FIG. 3, the towel engaging substrate 114 suitably provides a substrate against which the towel 104 is positioned for heating. The towel engaging substrate 114 is preferably a member characterized by an overall shape generally complementary to the shape of the substrate support member 116. More preferably, the substrate 114 is shaped in an overall letter “U” shaped configuration adapted to fittingly engage in general association with the inner surface 124 of the support member 116. Similar to the support member 116, the substrate 114 is defined by a pair of opposed and generally vertical walls 132, 134 preferably maintained in a spaced apart relationship by a connecting portion 136. More preferably, the walls 132, 134 and the connecting portion 136 are a unitary construction, overall further including an outer surface 140 and an inner surface 138. The walls 132, 134 and connecting portion 136 are preferably of any suitable dimensions particularly suited for the accommodation of a towel. More preferably, the walls 132, 134 and connecting portion 136 are characterized by a length slightly shorter than the length of a conventional bath towel, thereby resulting in a portion of the towel 104 being laterally exposed from the device 100 when the towel 104 is associated with the device 100, which exposed portion suitably assists a user in removing the towel 104 therefrom. Further, the substrate 114 is preferably constructed from an appropriate metal and/or alloy displaying desired thermal and conformational properties, or any other suitable material, such as appropriate plastics.

The substrate 114 connecting portion 136 is preferably an arcuate and generally semispherical member disposed in a manner that translates its curvature to the walls 132, 134. Preferably, the curvature maintains the walls 132, 134 in spaced apart and slightly angularly offset relationship to each other. Accordingly, bottom portions of the walls 132, 134 (i.e., those portions generally near the connecting portion 136) are generally spaced apart by a distance that is smaller than the distance separating upper portions of the walls 132, 134 (i.e., those portions generally distal to the connecting portion 136). This arrangement suitably facilitates the insertion of a towel 104 into the device 100 by endowing the device 100 with an overall funnel-like, upwardly tapered characteristic.

The connecting portion 136 is preferably constructed from a suitable material, such as an appropriate metal, that imparts a degree of resilient flexibility and biasing on the portion 136. Preferably, the walls 132, 134 are spaced apart and angularly offset in a manner that causes a towel 104 placed therebetween to be slightly compressed, which compression is effectuated by the arcuate and resiliently flexible nature of the connecting portion 136. Applying a compressive force to the towel 104 suitably increases the transfer of heat to the towel 104 generated by the resistance heating mat. In general, the shape and properties of the substrate 114 are preferably adapted so as to be cooperative with the shape and properties of the support member 116. Additionally, the substrate 114 may include a plurality of perforations therein for increasing the communication of heat from the heating mat therebehind to the towel 104 associated with the substrate 114.

The towel engaging substrate 114 suitably cooperates with the support member 116 to define a cavity therebetween when the substrate 114 is positioned in association with the support member 116. The cavity operates as a situs for the positioning of the resistance heating mat and, in a preferred embodiment, the resistance heating mat is disposed along substantially the entire portion of the cavity, i.e., along substantially the entirety of the engaging substrate 114 inner surface 138 and the entirety of the support member 116 inner surface 124. With reference to FIG. 3, the substrate 114 and the support member 116 suitably each include structure that cooperates to define the cavity. In a preferred embodiment, the substrate 114 includes a lip 142 running along substantially the entire length of each of its lateral edges in a generally perpendicular manner toward the inner surface 138. The substrate 114 also suitably includes a rim 144 extending along substantially the entire length of its upper edges in a generally perpendicular manner toward the inner surface 138 and, preferably, is continuous with the lips 142. Similarly, the support member 116 preferably includes a channel 130 running along substantially the entire length of each of its lateral edges. Accordingly, when the substrate 114 is associated with the support member 116, the substrate 114 lips 142 insert into and are engaged by the support member 116 channels 130 and the substrate 114 rims 144 associate with and overlie an upper edge portion of the support member 116, thereby defining a generally closed cavity between the substrate 114 and the support member 116. The resistance heating mat is preferably disposed in the cavity between the support member 116 and the substrate 114 and is preferably provided with components and in a configuration consistent with the heating mat discussion provided above.

The towel warming device 100 suitably also includes one or more bases 106 associated therewith for maintaining the device 100 in a desired orientation. With reference to FIGS. 1-4, a preferred base 106 is provided as a foot-like member adapted to maintain the supporting member 116 in an upright, generally vertical orientation. The base 106 is preferably an elongate generally rectangular member having a surface engaging portion 145 and a support member 116 engaging portion. The surface engaging portion 145 is preferably generally flat and adapted to be positioned on an appropriate surface, such as ground, carpet, countertop, etc. and may additionally include features thereon for increasing the frictional engagement (e.g., to avoid slippage of the device 100) between the base 106 and the surface upon which it is positioned. The support member 116 engaging surface 144 preferably includes an arcuately recessed portion adapted to receive the arcuate connecting portion 122 thereon and stabilize the device 100 thereby. Preferably, the support member 116 is fixedly secured to the base(s) 106; more preferably, the support member 116 is secured to the base(s) 106 through one or more fasteners (e.g., rivet-like screws), adhesive, and the like. It is to be appreciated that the disclosure of the base(s) 106 is by way of example only and that the warming device 100 need not include the base(s) 106. Alternatively, the device 100 may be adapted with appropriate structure for enabling the device 100 to be suspended from a conventional wall mounted towel rack. Additionally, the device 100 may be configured so that the base(s) 106 enable the support member 116 to lie horizontally, characterized by the walls of the generally “U” shaped structure extending in a horizontal plane.

The warming device 100 suitably also includes control circuitry, generally denoted by numeral 108 in FIG. 1, adapted for receiving user-generated actuation of the warming device 100. The circuitry 108 is preferably as previously described and is maintained within a control housing 146 associated with the support member 116 in a manner that enables communication between the control circuitry 108 and the resistance heating mat. In a preferred embodiment, the control housing 146 is provided as a member generally complementary in shape to the support member 116 and includes a pair of generally vertical walls 150, 152, and a connecting portion 154 maintaining the walls 150, 152 in generally spaced apart configuration. The housing 146 is preferably associated with a bottom portion of the outer surface 126 of the support member 116 in an orientation generally transverse to the support member 116.

The control circuitry 108 suitably includes an electrical power cord 110 coupled to the heating mat and adapted to interface with a source of electrical current, as previously described. In a preferred embodiment, the power cord 110 is a ribbon-like generally flat cord and is adapted to interface with a conventional wall-mounted source of electrical current through a conventional male plug adaptor 112.

The control housing 146 suitably includes a user interface with which the user interacts in directing operation of the warming device 100. According to a preferred embodiment, the user interface comprises a user actuable switch 148 that is communicatively coupled to the resistance heating mat in a manner that actuation of the switch 148 causes electric current to flow to the heating mat. More preferably, the switch 148 is coupled to a timer element, actuation of which suitably causes the heating mat to operate for a predetermined period of time. The switch 148 is preferably disposed along a slot 156 fashioned in the control housing and is moveable in a linear fashion throughout the slot 156, similar in configuration and operation to a bread toasting appliance actuating mechanism. In operation, a user grasps a protruding flange 158 associated with the switch 148, depresses the flange 158 through the slot 156 to its lowermost position. Once the switch 148 is so depressed, the heating mat becomes actuated and emits heat therefrom. Additionally, the timer element operates to gradually return the switch 148 to its beginning position as the predetermined period of time elapses. Once the switch 148 has returned to its beginning position, electric current ceases to be supplied to the heating mat. It is to be appreciated that any other user interface may be provided for enabling a user to actuate operation of the heating mat, such as the various examples discussed herein.

The warming device 100 suitably also includes associated with a bottom surface of the control housing 146 a mechanism 160 adapted for spooling the electrical cord 110. The mechanism 160 suitably enables spooling of the electrical cord 110 in a manner that reduces the amount of electrical cord 110 exposed. The mechanism 160 is preferably rotatably mounted to a bottom surface of the connecting portion 154 of the control housing 146 and includes associated therewith a spool (not shown) adapted for receiving the cord 110 wrapped therearound for storage. The mechanism 160 suitably also includes an engagement surface 164, such as a hole member adapted to receive a user's finger therein, for enabling a user to rotate the mechanism 160 and spool the cord 110 thereby. Additionally, the control housing 146 suitably includes a channel 162 therein for passage of the electrical cord 110.

The warming device 100 of the present invention is adapted to be positioned and/or located in any of a plurality of locations. For example, the device 100 is configured to be positioned atop a tank component of a conventional bathroom toilet. Accordingly, the device 100 may suitably be positioned so that its base(s) 106 interfaces with an upper surface of the tank and lies thereon. Additionally, upper portions of the support member 116 may include fastener holes therein adapted to allow the device 100 to both lie on the tank and be fastened to the wall behind the tank. Alternatively, the device 100 may be positioned on a ground surface, on a countertop surface, on a shelf surface, directly against a wall (and be fastened thereto), or in any appropriate location. With reference to the example ground surface location, the flange 158 of the switch 148 may suitably be of elongate configuration so as to enable a user to actuate the device 100 through engagement of the user's foot with the flange 158. With reference to the example shelf location example, the device 100 may suitably be positioned so as to lie on a side of the support member 116.

According to yet another embodiment, the device 100 may suitably be configured so as to pend or otherwise be removably suspended from any suitable support, such as a conventional wall-mounted towel bar. Accordingly, one or more arm-like members, straps, or other suitable structure may suitably extend from the device 100, preferably from an area in proximity to upper portions of the support member 116, and be adapted to position on, e.g., the towel bar. In general, the device 100 is of a configuration particularly adapted to be positioned in a location, for example in a bathroom, that otherwise remains unoccupied, thereby reducing the obstruction created by positioning the device 100 in the typically small confines of a bathroom.

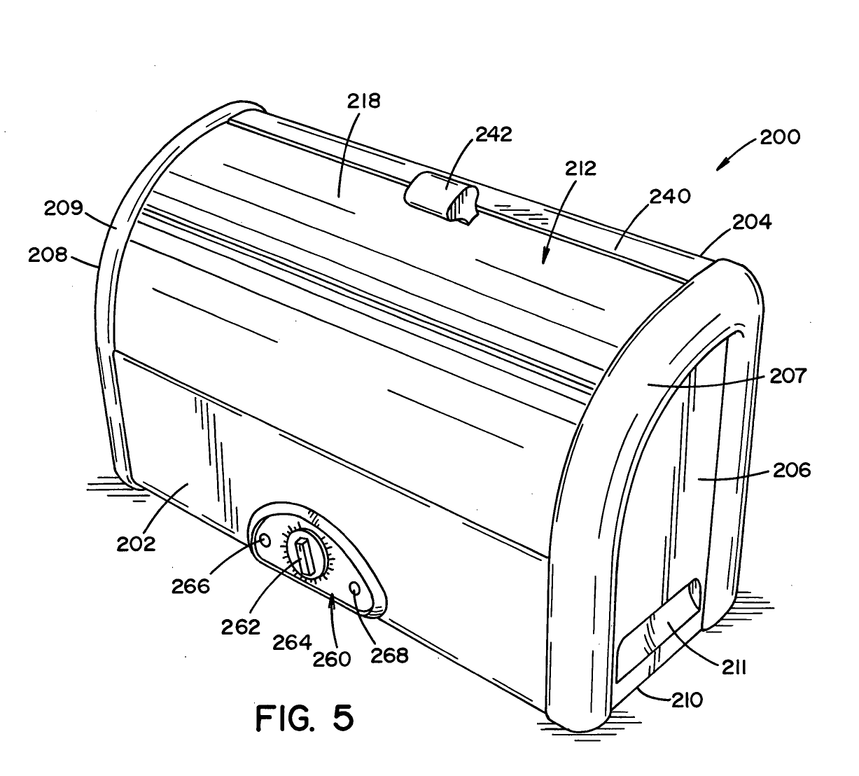

A second example embodiment of a preferred warming device 200 is provided with reference to FIGS. 5-9. The second example warming device 200 generally includes a device body, a heating element disposed therein, and control circuitry for controlling the operation of the heating element 216. The device body is preferably of any suitable construction and configuration that generally defines an inner cavity adapted for maintaining a towel during the heating thereof and preferably also includes an access door for providing selectable access to the inner cavity.

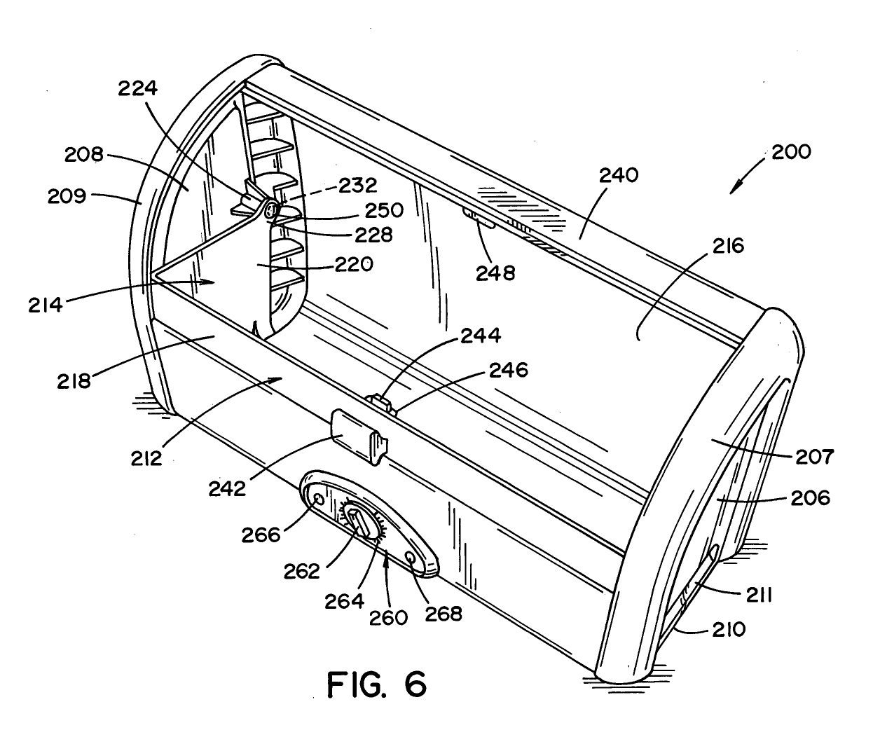

With reference to FIGS. 5 and 6, illustrated is a preferred example warming device 200 illustrating a preferred device body configuration. The device body generally includes a front wall 202, a rear wall 204, spaced apart side walls 206, 208, a bottom wall 210 and an access door 212. The front wall 202 and rear wall 204 are preferably disposed in spaced apart and generally parallel relationship to each other and together define the front and rear portions of the device body. The front wall 202 is preferably of reduced height relative to the rear wall 204, with the rear wall 204 vertically extending to a larger extent than the front wall 202. The reduced height profile of the front wall 202 suitably configures the device body in a manner for maintaining the access door 212 thereabove, as will be more fully illustrated below. Additionally, the rear wall 204 preferably includes a flange-like lip member 240 extending perpendicularly from a top portion of the rear wall 204 and toward the front wall 202, and generally defines a top portion of the device body. As will be more fully discussed below, the lip member 240 cooperates with the access door 212 to define a closing interface for the device 200.

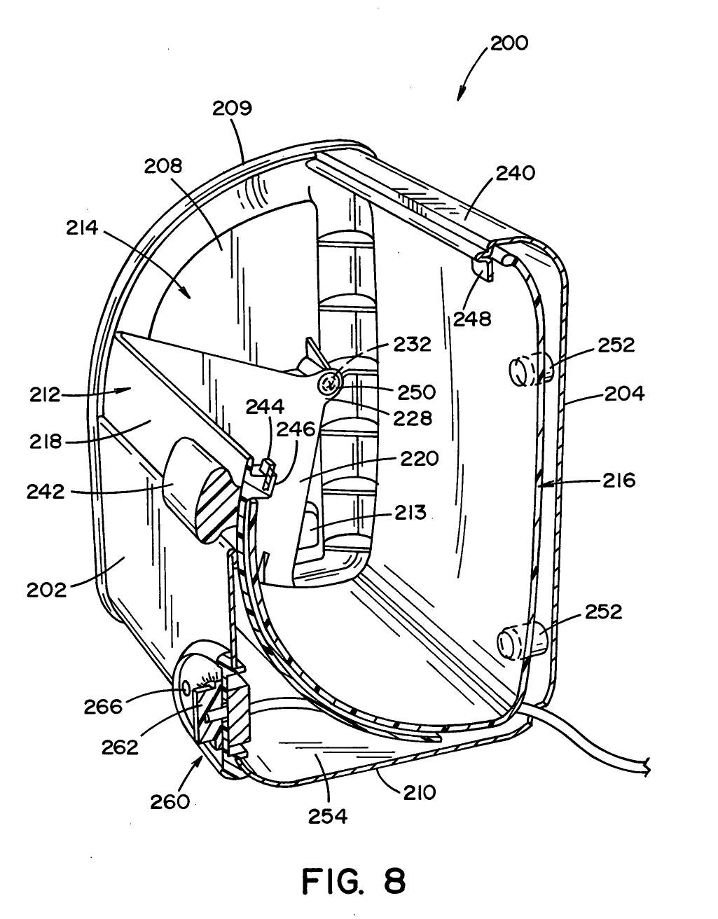

The bottom wall 210 of the device body suitably defines a bottom portion of the device 200. The bottom wall 210 is preferably a component integral with the front wall 202 and the rear wall 204, and is suitably disposed relative thereto in perpendicular configuration and is of a sufficient length so as to maintain the front and rear walls 202, 204 in a desired spaced apart relationship. The bottom wall 210 preferably cooperates with the front wall 202 and the rear wall 204 to define a generally cross sectional letter “J” like configuration (as best seen in FIG. 8), the reduced leftward vertical portion being defined by the reduced height front wall 202.

According to a preferred embodiment, the front wall 202, bottom wall 210 and rear wall 204 are a unitary structure produced by, for example, extrusion molding techniques. Subsequent to extrusion, the unitary structure is manipulated so as to adopt the preferred “J” shape configuration through conventional material manipulation techniques. The unitary structure is constructed from any material exhibiting desired strength and thermal properties, such as sheet metal, appropriate plastics, or other suitable material. It is to be appreciated that the unitary structure aspect of the walls 202, 210, 204 is by way of example only and that the body may suitably be constructed of a plurality of distinct components mechanically associated therewith to be assembled into the device body.

The side walls 206, 208 of the device body are preferably disposed in a spaced apart and generally parallel relationship and in abutting engagement with the respective lateral ends of the front wall 202, rear wall 204 and bottom wall 210. The side walls 206, 208 are accordingly cap-like members that cooperate with the preferable unitary front, rear and bottom wall structure to complete the lateral vertical walls of the device body and to define an inner cavity 214.

As illustrated in FIGS. 5 and 6, the side walls 206, 208 preferably comprise arcuate portions 207, 209 that define a portion of both an upper edge and a side edge thereof. The arcuate portions 207, 209 preferably originate from a side edge of the side walls 206, 208 at a position generally in proximity to an upper portion of the front wall 202 and advance therefrom in a rounded configuration terminating at a position generally in proximity to the lip member 240 of the rear wall 204. As will be more fully described below, the side wall arcuate portions 207, 209 cooperate with the access door 212 to accommodate an arcuate surface thereof.

The side walls 206, 208 are constructed from any material exhibiting desired strength and thermal properties, such as sheet metal, appropriate plastics, or other suitable material. Most preferably, the side walls 206, 208 are constructed of a suitable plastic by injection molding techniques. The side walls 206, 208 may additionally comprise a handle 211, 213 associated therewith to facilitate a user's transport and/or manipulation of the device 200. Such handles 211, 213 may be provided as distinct components pivotally associated with the side walls 206, 208, as a unitary structure defined by the contours of an employed mold, or as any other appropriate structure.

The device body preferably also includes the inner cavity 214 therein providing a situs for the heating mat 216 and a towel associated therewith. The inner cavity 214 is preferably defined by the front wall 202, rear wall 204, bottom wall 210, side walls 206, 208, and the moveable access door 212.

The device body also includes the access door 212 for selectably providing access to the inner cavity 214. The access door 212 is moveable between a closed state (FIG. 5), in which access to the inner cavity 214 is prevented, and an open state (FIG. 6), in which access to the inner cavity 214 is enabled. The access door 212 is suitably defined by an elongate longitudinal portion 218 and a pair of arms 220, 222 extending perpendicularly relative to the longitudinal portion 218 and collinearly relative to each other. The elongate longitudinal portion 218 is preferably fashioned in an arcuate manner along its longitudinal axis, thereby endowing the access door 212 with a cross sectional overall semispherical configuration. The semispherical configuration of the access door 212 generally mirrors the arcuate configuration of the side walls 206, 208 to provide an overall rounded longitudinal edge for the towel warming device 200.

The access door arms 220, 222 preferably cooperate with the towel warming device 200 to enable the access door 212 to pivot between the open and closed positions. According to a preferred embodiment, the arms 220, 222 have an overall plan shape generally as a circular quadrant, the arcuate surfaces of which interface with a bottom face of the access door 212 and extend therefrom into generally tapered portions 228, 230. Further according to the preferred embodiment, the tapered portions 228, 230 of the arms 220, 222 interface with inner surfaces of the side walls 206, 208 in a pivot assembly that provides for the pivoting of the access door 212.

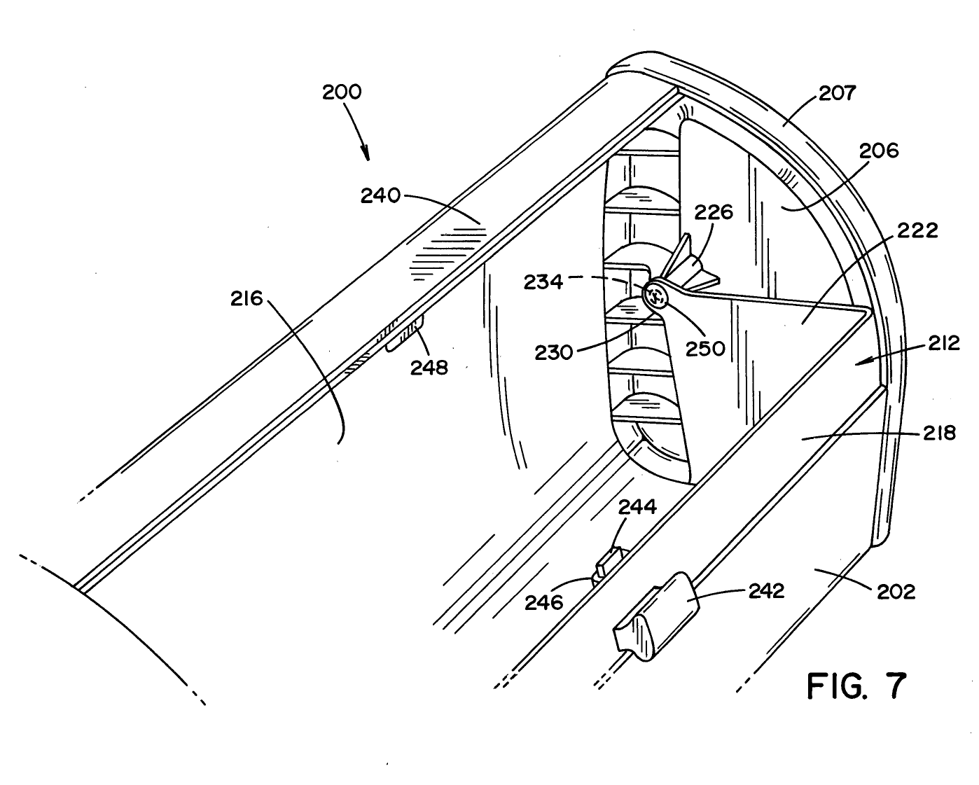

With reference to FIG. 7, the pivot assembly is defined by an interface between the access door 212 and the device body. According to a preferred embodiment, the assembly comprises boss members 224, 226 extending from the side walls 206, 208 generally perpendicularly to the side walls 206, 208 and toward the inner cavity 214. The boss members 224, 226 are associated with the side walls 206, 208 in a suitable position that enables interface between the boss members 224, 226 and the tapered portions 228, 230. The tapered portions 228, 230 preferably include a hole 232, 234 bored therethrough and adapted to overly a corresponding bore (not shown) extending through the boss members 224, 226. The pivot assembly preferably also includes a pivot pin-like fastening member 250, such as a rivet, disposed through the holes 232, 234 of the arms 220, 222 and the bores of the boss members 224, 226, which fastening member 250 securely associates the access door 212 with the device body, thereby also enabling the pivoting of the access door 212.

The access door 212 also preferably includes a handle 242 associated therewith for facilitating a user's manipulation of the access door 212. The handle 242 is any suitable structure that is easily grasped and held throughout the opening and closing of the access door 212.

The towel warming device 200 suitably also includes means adapted for securing the access door 212 in a closed arrangement. According to a preferred embodiment, the securing means is provided as a magnet 244 associated with the access door 212 and adapted to magnetically associate with a corresponding structure on the device body. More particularly, the access door 212 preferably includes an inwardly (i.e., toward the inner cavity 214) projecting shoulder portion 246 configured to maintain the magnet 144 in secure association with the access door 212. Additionally, the rear wall 204, more preferably the lip member 240 of the rear wall 204, includes a flange-like magnet engaging portion 248 adapted to magnetically interact with the magnet 244 when the magnet 244 is positioned in proximity to the magnet engaging portion 248 and to maintain the magnet 244 in proximity to the magnet engaging portion 248, thereby securing the access door 212 in a closed position. It is to be appreciated that other means for securing the access door 212 in closed arrangement are contemplated and include, for example, a solenoid latch, mechanical fasteners, hook and loop fasters, etc.

It is to be appreciated that the foregoing discussion of the access door 212 is by way of example only and that a variety of possible configurations for the access door 212 are contemplated. For example, the access door 212 may suitably be associated with the device body in alternative pivoting arrangement according to which the access door 212 pivots upward and away from the device body to expose the inner cavity 214. By way of additional example, the access door 212 may suitably be provided in an accordion-like arrangement of a plurality of gussets adapted to compact into a condensed state and thereby provide access to the inner cavity 214. Any other suitable door member enabling selectable access to the inner cavity 214 may be employed with the device 200 of the present invention.

The device body may be constructed of any suitable dimensions and in any suitable configuration. The body is preferably constructed so as to have an inner cavity 214 of a volume sufficient for receiving any of a plurality of towel types and sizes, with especially regard given for the frequently employed oversized bath towels. The body may suitably also be of a configuration sufficient for accommodating more than one towel, as many individuals prefer the use of more than one towel during bodily drying.

The towel warming device 200 also includes the heating element for heating a towel placed in the device inner cavity 214. According to a preferred embodiment, the heating element is provided as a heating mat 216 disposed in the inner cavity 214 of the device 200 and adapted to substantially envelope a towel placed therein, thereby maximizing the extent of contact between the towel and the heating mat 216 and amount of heat transferred thereto, which heating mat is substantially as described above.

With reference to FIG. 8, the heating mat 216 is a generally rectangular and substantially thin body disposed in the inner cavity 214. More preferably, the heating mat 216 is disposed along at least a portion, more preferably substantially all, of inner surfaces of the rear wall 204, the bottom wall 210 and the front wall 202, thereby substantially mirroring the overall letter “J” shape of the device body and providing a pocket-like arrangement adapted to receive the towel therein. Even more preferably, the heating mat 216 is maintained in spaced apart relationship to at least one of the walls 202, 204, 210 so as to minimize the amount of heat transferred to the walls 202, 204, 210 and to reduce the risk of injury associated with accidentally contacting a heated external surface. Spacer assemblies 252 are preferably provided so as to enable the spaced apart relationship, which assemblies generally include boss-like members extending from the inner surfaces of the walls 202, 204, 210 adapted to cooperate with rivet-like fasteners positioned through the heating mat 216 and in association with the boss members.

FIG. 8 illustrates a particularly preferred example configuration for the arrangement of the heating mat 216 within the inner cavity 214. As illustrated, the heating mat 216 approaches an upper edge of the front wall 202 in an arcuate manner that defines therebelow a generally closed cavity 254, which cavity 254 is more particularly defined by a bottom surface of the heating mat 216, a portion of an upper surface of the bottom wall 210, and substantially all of an inner surface of the front wall 202. As will be more fully described below, the cavity 254 suitably provides a convenient location for the placement of the control circuitry components that control the operation of the heating mat 216. Additionally, the cavity 254 defines an area into which the access door 212 is maintained when the door 212 is in the open position, according to which configuration the heating mat 216 overlies the closed access door 212 and remains proximate to the inner cavity 214.

The towel warming device 200 additionally comprises control circuitry adapted for controlling the activation of the heating mat 216, substantially as described above. Thus, for example, the control circuitry includes a means adapted for coupling the heating mat 216 to the source of electrical energy, such as a conventional electric cord (not shown). The electrical cord is preferably provided in substantial length to facilitate positioning of the towel warming device 200 in any desired position. Even more preferably, the electrical cord is retractable into the body of the towel warming device 200 to simplify storage of the device 200 and to reduce the amount of unneeded cord being exposed from the device 200. Alternatively, an exterior surface of the rear wall 204 may suitably include one or more projections protruding therefrom adapted for receiving the electric cord wrapped therearound for convenient storage of the electrical cord.

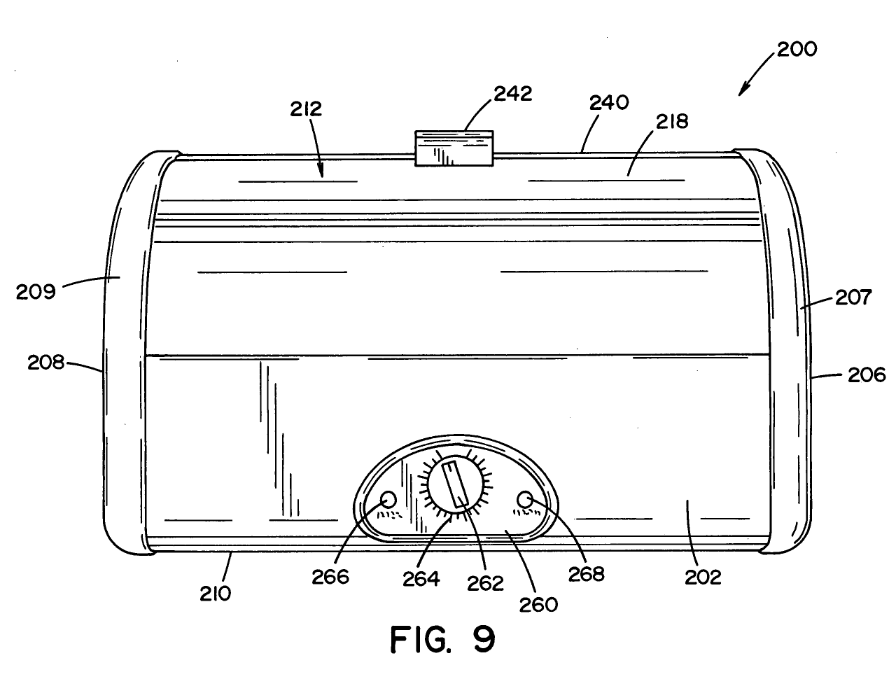

With reference to FIG. 9, the control circuitry of the device 200 also includes the user interface 260 for receiving user-generated activation of the towel warming device 200. According to an example preferred embodiment, the user interface 260 includes a knob, preferably a timer-connected knob, represented by the numeral 262, generally disposed as an analog, rotary dial type, for receiving user activation of the device 200. The knob 262 is preferably flanked by a plurality time indicia for enabling a user to rotate the knob 262 to a desired duration. Accordingly, the user preselects a desired time for the device 200 to be activated and rotates the knob 262 to the preselected time. Upon rotation of the knob 262 passed a zero time indicium, the heating mat 216 receives electrical current therethrough, heats a towel placed in the inner cavity 214 and continues to so dissipate heat for the preselected period of time. As the preselected period of time elapses, the knob 262 rotates toward the zero time indicium. When the preselected period of time has elapsed, the knob 262 passes the zero time indicium, which passing causes the electrical current to cease being transmitted to the heating mat 216. The user interface 260 may additionally include the programmable interface and/or the means adapted for receiving user selection of a desired temperature, as previously described.

The user interface 260 may additionally comprise means adapted for providing certain information to the user, as previously described. Thus, for example, the interface 260 may include means adapted for informing the user when the device 200 is active and heating a towel. Such means may include, for example, a light emitting diode 266 (“LED”) coupled to the control circuitry and adapted to be illuminated when current is passing to the heating mat 216. Additionally, the LED 266 may suitably be positioned in proximity to a written indicium, such as a “heating” indicium that enables a user to understand the information being conveyed by the LED. Additional information providing means may be provided, such as an LED 268 adapted to inform when the device 100 is in a cool down mode, etc.

The control circuitry may comprise additional elements for influencing activation of the heating mat 216 as previously described. Thus, for example, the control circuitry may suitably include a temperature cutoff switch, such as a bimetallic over temperature cutoff switch, having a temperature sensor adapted to sense the temperature of the inner cavity 214. The switch is a conventional switch, preferably responsive to a preselected temperature value and adapted to prevent the flow of current to the heating mat 216 upon attainment of the preselected temperature value.

The example warming device 200 is adapted to be positioned and/or located in any of a plurality of locations. For example, the device 200 is configured to be positioned atop a tank component of a conventional bathroom toilet. Accordingly, the device 200 may suitably be positioned so that its bottom wall 210 interfaces with an upper surface of the tank and lies thereon. Additionally, upper portions of the rear wall 204 may include fastener holes therein adapted to allow the device 200 to both lie on the tank and be fastened to the wall behind the tank. Alternatively, the device 200 may be positioned on a ground surface, on a shelf surface, directly against a wall (and be fastened thereto), or in any appropriate location. With reference to the example shelf location example, the device 200 may suitably be positioned so as to lie on its rear wall 204.

According to yet another embodiment, the device 200 may suitably be configured so as to pend or otherwise be removably suspended from any suitable support, such as a conventional wall-mounted towel bar. Accordingly, one or more arm-like members may suitably extend from the device 200, preferably from an area in proximity to upper portions of the rear wall 204, and be adapted to position on, e.g., the towel bar. In general, the device 200 is of a configuration particularly adapted to be positioned in a location, for example in a bathroom, that otherwise remains unoccupied, thereby reducing the obstruction created by positioning the device 200 in the typically small confines of a bathroom.

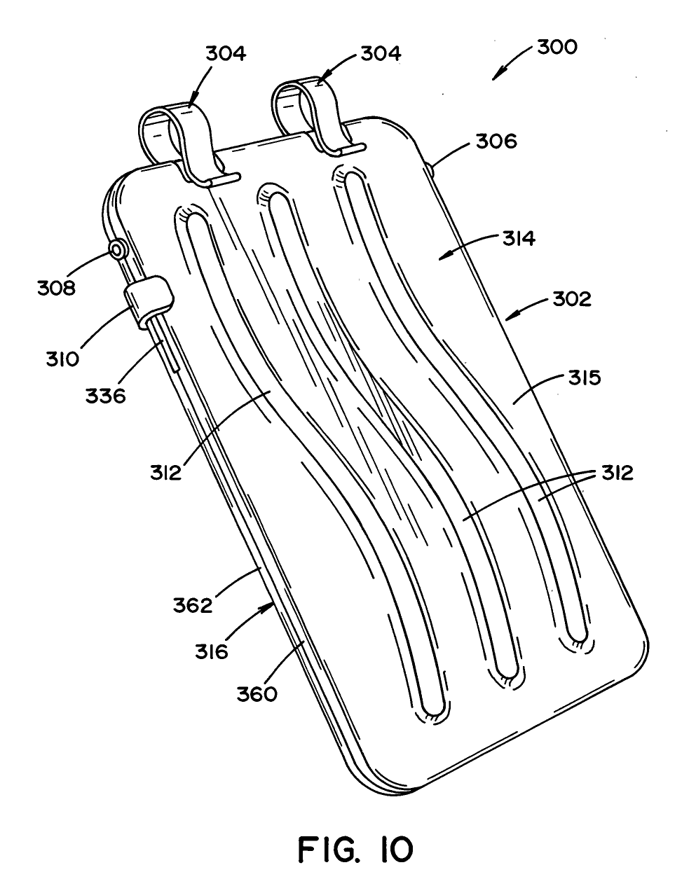

An example third embodiment of a warming device 300 according to the present invention will now be discussed with reference to FIGS. 10-15. The example warming device 300 is preferably a rectangular mat-like member of a configuration adapted to be suspended from a wall mounted towel rack and warm a towel by being positioned alongside a towel draped over the towel rack.

With reference to FIG. 10, the example warming device 300 preferably includes an elongate rectangular mat-like body 302, at least one fastener 304 associated therewith for suspending the device 300 from a towel rack, an electrical interface 306, and a user interface 310. The body 302 preferably includes one or more elongate and sinuously disposed striations 312 thereon for increasing the aesthetic appearance of the device 300 and for generally increasing heatably operable surface area.

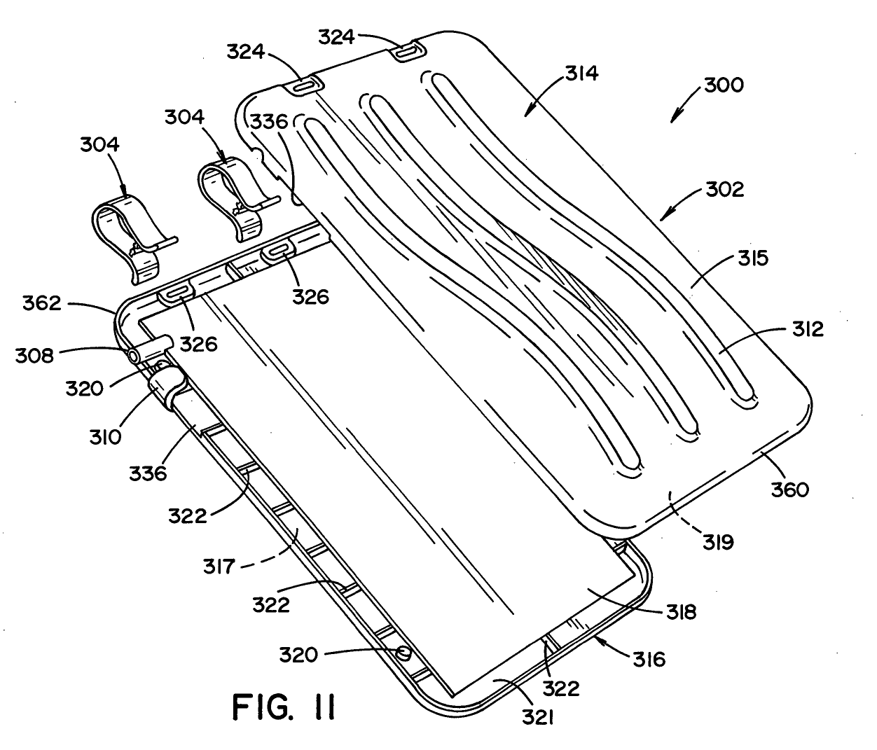

With reference to FIG. 11, the device 300 body 302 preferably includes a first layer 314 and a second layer 316, each of which is preferably a general mirror image of the other and disposed as an elongate rectangular mat having a outer surface 315, 317 and an inner surface 319, 321. The layers 314, 316 are securely engageable with each other through a locking mechanism, such as a pin-like member 320 protruding from the inner surface 321 of the second layer 316 and adapted to fittingly engage with a complementary structure located on the inner surface 319 of the first layer 314, and the like. The layers 314, 316 preferably also include rim-like edge flanges 360, 362 adapted to interact with each other in a manner that increases the fitting engagement therebetween.

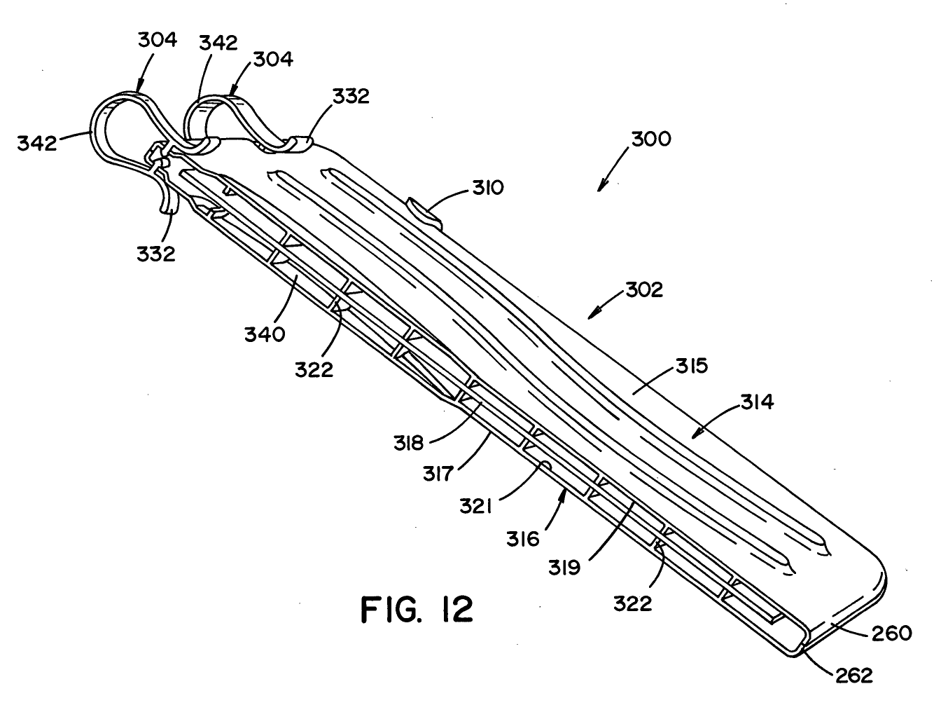

With reference to FIGS. 11 and 12, the first layer 314 and second layer 316 preferably cooperate with each other to define an inner cavity 340 therebetween. The edge flanges 360, 362 of each of the layers 314, 316 preferably protrude in a manner that their abutting engagement positions the inner surfaces 319, 321 of the layers 314, 316 in spaced apart relationship, thereby resulting in creation of the inner cavity 340. A heating mat 318, preferably having features and functions substantially as described above, is disposed in the inner cavity 340. The heating mat 318 is preferably oriented in the cavity 340 generally coplanar with the layers 314, 316 and emanates heat therefrom in a manner that causes the outer surfaces 315, 317 of the layers 314, 316 to be heat radiating surfaces.

With continued reference to FIGS. 11 and 12, the inner surfaces 319, 321 of the layers 314, 316 preferably comprise a plurality of rib-like protrusions 322 extending thereon. The ribs 322 preferably maintain the heating mat 318 in spaced apart relationship relative to the layers 314, 316 and thereby reduce the heat profile of the layers 314, 316 outer surfaces 315, 317. Additionally, the ribs 322 provide a structurally reinforcing framework that imparts rigidity to the body 302.

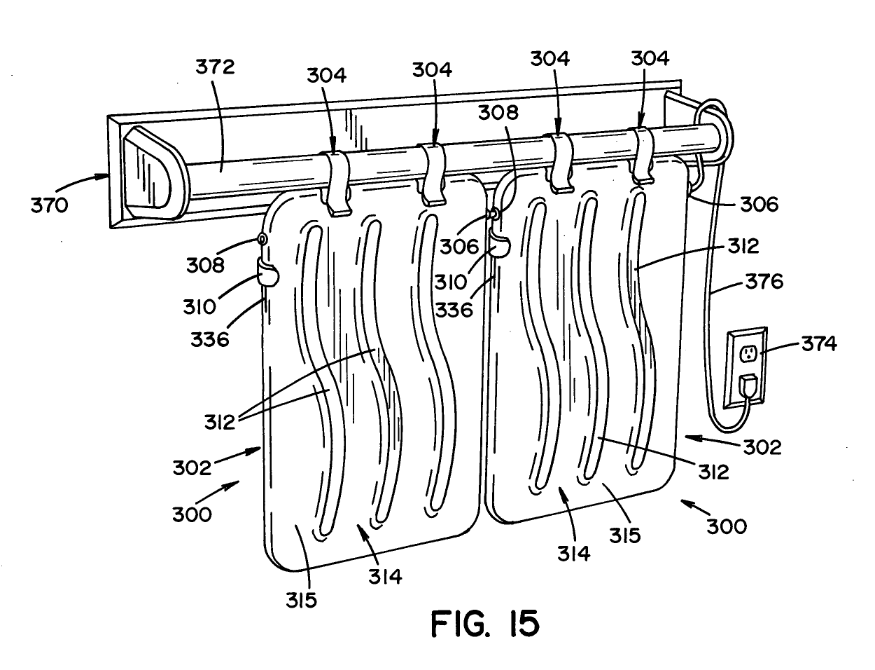

The warming device 300 suitably also includes at least one fastener 304 for releasably suspending the warming device 300 from a conventional wall mounted towel rack 370 (FIG. 15). In a preferred embodiment, the fastener(s) 304 is generally an elongate strap-like member releasably securable to the device 300 and adapted to fittingly engage around a tubular portion 372 of the towel rack 370 and maintain the warming device 300 in proximity thereto.

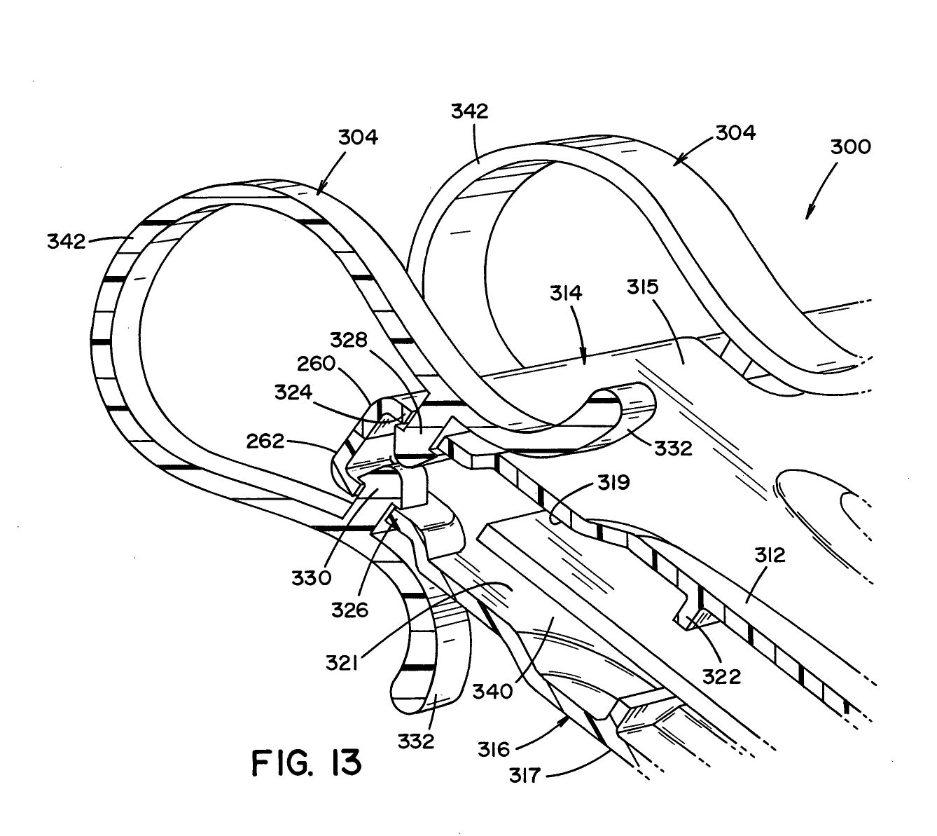

With reference to FIGS. 11 and 13, the fastener 304 is preferably an elongate strap-like member characterized by user graspable portions 332 associated with opposite ends of the strap, body 302 engaging portions 328, 330, and a towel rack engaging portion 342. In a preferred embodiment, the towel rack engaging portion 342 is a centrally located portion of the fastener 304 strap and is adapted to be arcuately disposed about and lay on the tubular portion 372 of the towel rack 370. The body 302 engaging portions 328, 330 are preferably a pair of members each positioned distal to the rack engaging portion 342 and protruding from the strap collinearly. With reference to the body engaging portions 328, 330, each layer 314, 316 preferably includes a fastener engaging portion 324, 326 adapted to releasably and securely receive the body engaging portions 328, 330 therein. In a preferred embodiment, the fastener engaging portions 324, 326 are provided as apertures fashioned in each layer 314, 316 and the body 302 engaging portions 328, 330 are provided as protruding portions having appropriate structure adapted to pass into and fittingly engage with the fastener engaging portions 324, 326. Additionally, the user graspable portions 332 are preferably terminal portions of the fastener 304 strap and provide graspable structure for a user to engage during either associating the device 300 with a towel rack or for disassociating the device 300 from a towel rack. It is to be appreciated that the foregoing discussion of the fastener 304 is by way of example only and that any suitably structure may be employed for suspending the warming device 300 from a towel rack. Additionally, the fastener 304 may be a strap-like member one end of which is fixedly secured to the warming device 300 and the other end of which is suitably manipulable to be secured around a towel rack and subsequently associated with the warming device 300.

With reference to FIGS. 10, 11, 14 and 15, the warming device 300 also includes an electrical interface 306 as a component of its control circuitry for coupling the warming device 300 to a source of electrical current, such as a wall outlet 374, a battery pack, etc. The electrical interface 306 is preferably a female-like coupling adapted to be engaged by a complementary male adaptor associated with a power cord 376 or other suitable structure. More preferably, the power cord 376 is an elongate electric coupling member having a male prong-like adaptor integrated with a terminal end thereof and a wall outlet engaging adaptor integrated with the other terminal end thereof. The male adaptor suitably is releasably engageable with the electrical interface 306 in a manner that facilitates storage and/or disassembly of the warming mat 300. Additionally, the wall outlet adaptor suitably includes a substantially flat coupling having a pair of outlet engaging prongs protruding therefrom, thereby assuming a substantially small size profile.

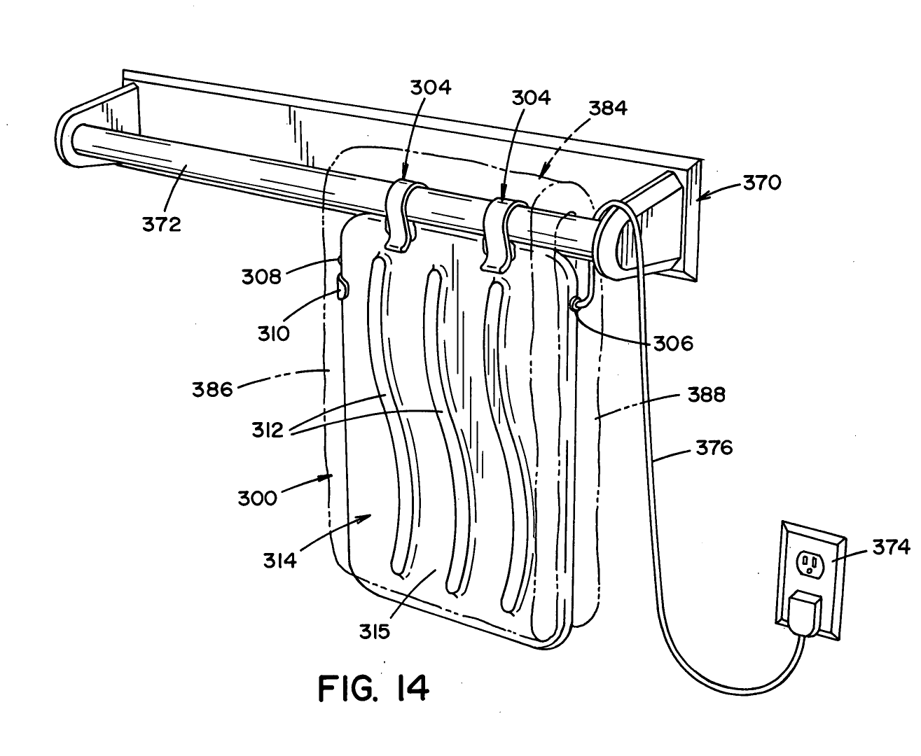

In a preferred embodiment, the warming device 300 is adapted to be suspended tandemly in a pair arrangement with a second warming device 300 from a towel rack 370, as illustrated in FIG. 14. More preferably, the warming device 300 is adapted to be electrically couplable to the second warming device 300, thereby obviating the need to directly couple the second warming device 300 to a, for example, wall outlet. With continued reference to the tandem arrangement example embodiment, the warming device 300 suitably also includes an additional electrical interface 308 adapted for mediating the electric coupling between the tandemly arranged warming devices 300. The electrical interface 308 is preferably a female-like coupling adapted to receive therein and be associated with a male-like prong integrated with a coupling means. The coupling means is suitably an electric cord or similar suitable structure having the male-like prong integrated with one end thereof and an additional male-like prong integrated with the other end thereof. The additional male-like prong is suitably associated with the electrical interface 306 of the second warming device 300. Therefore, when the first warming device 300 is coupled to a source of electric current and the electrical interface 308 of the first warming device 300 is coupled to the electrical interface 306 of the second warming device 300, the second warming device 300 is configured to operate and dissipate heat.

The warming device 300 also includes the user interface 310 for enabling a user to actuate operation of the warming device 300. In a preferred embodiment, the user interface 310 is a push button and/or slidable switch coupled to the control circuitry in a manner that its depression causes electrical current to flow to the heating mat 318. More preferably, the user interface 310 is a switch that is slidable along a slot 330 fashioned into one or more of the edge flanges 360, 362 of the device 300. The user interface 310 is also preferably coupled to a timer, substantially as described above, according to which actuation of the user interface 310 suitably actuates flow of electric current to the heating mat 318 for a predetermined period of time.

The warming device 300, particularly the layers 314, 316 and the fastener(s) 304, are constructed from any suitable material displaying desired thermal and structural properties. In a preferred embodiment, the layers 314, 316 and fastener(s) 304 are constructed from a suitable plastic as known to one of ordinary skill in the art. Additionally, the warming device 300 is preferably constructed of any suitable dimensions. In a preferred embodiment, the device 300 is suspended from a conventional towel rack, as shown in FIGS. 14 and 15. In operation, a user hangs a towel 384 from the towel rack so that a portion 386 of the towel is in contact with or in proximity to the outer surface 315 of the device 300 and another portion 388 of the towel is in contact with or in proximity to the outer surface 317 of the device. Accordingly, the dimensions of the warming device 300 are preferably chosen so that the warming device 300 is adapted to remain in contact with or in proximity to a portion of, and more preferably substantially all, of a towel positioned on the towel rack.

It is to be appreciated that the foregoing discussion of specific example warming device embodiments and components thereof is by way of example only. It is to be further appreciated that the foregoing discussion of specific components with reference to specific embodiments is also by way of example only and that any of the foregoing components may suitably be associable with any of the foregoing warming device embodiments, as desired and appropriate.

With reference to an additional example embodiment, the warming device of the present invention suitably includes means adapted for emitting active volatile substances, particularly perfume, into the atmosphere surrounding the warming device. More preferably, the means adapted for emitting active volatile substances is coupled to the warming device in a heat dependent manner according to which heat produced by the heating mat causes active volatile substances to be emitted.

In a preferred embodiment, the means adapted for emitting active volatile substances is provided by a consumable article adapted to diffuse active volatile substances in response to the action of heat on the consumable article. More preferably, the consumable article is a heat shrinkable material having the volatile substance impregnated therein. As the consumable article shrinks in response to the receipt of heat, the volatile substance is released therefrom.

With reference to a specific example embodiment, the consumable article is provided as heat shrink textile fibers, such as chlorofiber non-woven needled sheet bonded by a polyvinyl chloride resin. This material suitably displays the characteristics of being nonflammable and further being heat shrinkable at elevated temperatures when impregnated with a volatile substance. An additional suitable consumable article is, for example, a polyamide resin body, such as a Versalon™ type polyamide resin body. Preferable polyamide resins are fatty polyamides, such as diamines, triaminesand relatively high molecular weight dibasic acids, especially those that result from dimerization of diunsaturated carboxylic acids (e.g., the condensation products of dimerized linoleic acid and ethylene diamine). These types of resins are especially advantageous as they substantially retain their hardness at room temperature. The volatile substances are preferably perfume oils, such as, for example, complex mixtures of volatile compounds including esters, ethers, aldehydes, nitrites, alcohols, unsaturated hydrocarbons (e.g., terpenes) and the like well known to a person of ordinary skill in the art. The volatile substance is preferably present in the consumable article in an amount by weight of approximately 5-70%, and more preferably in a proportion adapted to yield a controlled release of the volatile substance at a steady rate as desired. Various other substances may be added to, combined with and/or replace the volatile substances, such as, for example, insecticides, bactericides, odorants, and the like. With further reference to the specific example embodiment, the volatile substance is preferably impregnated in a diluted form in an appropriate solvent, such as an oily glycol type solvent, particularly dipropylene glycol, ethylene diclycol and the like.

In a preferred embodiment, the means adapted for emitting active volatile substances is preferably fashioned into a compacted and uniform size adapted to be received into and maintained by a pocket-like sleeve associated with the warming device. The means is suitable removable from the pocket upon the depletion of the volatile substances therein and a fresh means may be inserted into the pocket thereafter. The pocket is preferably located in a position of proximity to the heating mat, thereby increasing the efficiency of correlation between generation of heat by the heating mat and emission of volatile substances from the emitting means.

It is to be appreciated that the warming device of the present invention may be modified as appropriate depending on the desired application of the device. For example, it is contemplated that the device may suitably be associable with an outdoor hot tub or similar whirlpool. According to the hot tub example embodiment, the device may suitable be modified so as to be waterproof and constructed from materials especially adapted to withstand exposure to outdoor elements. Further according to the hot tub example embodiment, the physical dimensions of the device may also be modified so as to enable the device to accommodate multiple towels, thereby simultaneously meeting the drying needs of multiple users. Additionally, as previously described, the device may suitably be adapted to be fastened to a wall, to be positioned on a surface, to be suspended from a towel rack, or in any other desired configuration. According to an example embodiment, the device may suitably be provided with a set of interchangeable components for enabling the user to choose the positional configuration of the device. With reference to yet an additional example embodiment, the device may suitably include a female plug socket adapted to receive an external power cord and enable the device to be tandemly connected to other electrically powered devices.

Example methods for warming an article, particularly a conventional bath towel, will now be discussed. The methods generally begin with a user preparing the towel warming device for use. In connection with the first warming device 100 embodiment and the second warming device 200 embodiment, the user positions the warming device 100, 200 in a desired position, such as atop a bathroom countertop, atop a toilet tank, on a bathroom floor, etc., and engages its electrical cord with a source of electrical current, such as a wall outlet. In connection with third warming device 300 embodiment, the user manipulates the fastener(s) 304 so that the fastener(s) 304 is disposed around the towel rack 370 tubular portion 372 and is suspending the warming device 300 therefrom; the user additionally couples the power cord 376 to a source of electrical current, such as the wall socket 374.

When the user contemplates the need for a warm towel, the user positions the towel in association with the warming device in a manner that will cause it to be heated thereby. With reference to the first warming device 100 embodiment, the user suitably obtains a towel 104, optionally folds the towel 104, and inserts the towel 104 into the device body 102. The insertion of the towel 104 may suitably require a small degree of force due to the biasing of the walls thereof by the connecting portions. With reference to the second warming device 200 embodiment, the user opens the device access door 212 by, e.g., grasping the access door handle 242 and sliding the access door 212 downward into stored position in the device inner cavity 214, as illustrated in FIG. 6, thereby enabling access to the device inner cavity 214. Having opened the access door 212, the user may suitably then insert a towel into the inner cavity 214. It is to be appreciated that, given the broad access aperture provided by the opening of the access door 212 and the elongate nature of the inner cavity 214, the towel may be inserted into the inner cavity 214 in any desired manner. For example, the towel can be neatly folded and carefully positioned within the inner cavity 214 or may alternatively be haphazardly stuffed into the inner cavity 214. Regardless of the configuration of the towel (i.e., in a folded state, a crumpled state, etc.), its positioning in the inner cavity 214 and its thereby being substantially enveloped by the heating mat 216 ensures that the towel will receive an amount of heat sufficient for elevating the temperature of the towel as desired. With reference to the third warming device 300 embodiment, the user suitably obtains the towel 384 and hangs the towel 384 from the towel rack 370 in a manner that a portion 386 of the towel 384 is in proximity to one side of the device 300 and another portion 388 is in proximity to another side of the device 300.

Having positioned the towel for heating, the user then actuate the flow of electric current to the resistance heating mat so that heat is dissipated thereby. With reference to the first warming device 100 embodiment, the user suitably actuates the flow of electric current by depressing the switch 148 through the slot 156. Depression of the switch 148 suitably actuates the flow of electric current, which flow is suitably prevented upon the return of the switch 148 to its starting position. Alternatively, actuation of the electric current flow by depression of the switch 148 may suitably be coupled to a timer mechanism that permits the flow only during a predetermined period of time, upon expiration of which the flow is discontinued. With reference to the second warming device 200 embodiment, the user suitably actuates the flow of electric current by rotating the knob 262. Rotation of the knob 262 suitably actuates the flow of electric current, which flow is suitably prevented upon the rotation of the knob 262 to its starting position. Alternatively, actuation of the electric current flow by rotation of the knob 262 may suitably be coupled to a timer mechanism that permits the flow only during a predetermined period of time, upon expiration of which the flow is discontinued. With reference to the third warming device 300 embodiment, the user suitably actuates the flow of electric current by depressing and/or sliding downward the user interface 310 through its slot 330. Depression of the user interface 310 suitably actuates the flow of electric current, which flow is suitably prevented upon the return of the user interface 310 to its starting position. Alternatively, actuation of the electric current flow by depression of the user interface 310 may suitably be coupled to a timer mechanism that permits the flow only during a predetermined period of time, upon expiration of which the flow is discontinued. It is to be appreciated that the foregoing discussion of means for receiving user actuation of the flow of electric current is by way of example only and that any suitably means may be employed, such as a switch, a depressable button, and the like.

Actuation of the flow of electric current may suitably also include the user inputting a desired duration for the actuation of the flow of electric current. According to one embodiment, the user actuates the heating mat by first mentally determining a desired heating duration. The user may suitably choose a heating duration so that the duration expires upon, e.g., the user's exit from a shower. In other words, the user estimates the amount of time the user will remain in the shower and then assigns that amount of time to be the towel heating duration. Once the duration has been determined, the user, e.g., rotates the knob 262 until it is aligned with a time indicium 264 corresponding to the desired duration. Upon rotation of the knob 262, electrical current passes to the heating mat and the towel is warmed as heat is dissipated therefrom.

Additionally, actuation may suitably include inputting a set of instructions into a programmable interface, which instructions direct the automatic operation of the warming device. In an example embodiment, the user actuates the heating mat by inputting the desired duration into a keypad-like interface coupled to control circuitry adapted to receive the inputted information and direct operation of the warming device accordingly. In yet another embodiment, the user may suitably input desired instructions into the user programmable mechanism so that operation of the device occurs in an automatic manner consistent with the input instructions. For example, the user may program the mechanism to instruct the device to actuate the heating mat every Monday through Friday at 6:30 for a duration of, e.g., seven minutes. Such instructions may enable the user to enjoy a warm towel upon exiting a shower if the user follows a routine of arising Monday through Friday at 6:30 and showering for seven minutes.

Once the user positions the towel as desired and actuates the flow of electric current to the warming device, the user suitably takes a shower. In connection with the example embodiment of the warming device including a timer mechanism, if the user showers for an amount of time generally consistent with the preselected heating duration, the user will be presented with a warm towel upon exit from the shower. However, should the user shower for either a longer or shorter duration than the heating duration, the user will still enjoy a warm towel. The heating mat suitably activates quickly and begins dissipating heat shortly after the initial passing of current therethrough. Accordingly, if the user showers for a shorter duration than the heating duration, the towel will still receive a significant amount of heating. Conversely, the heating mat retains a significant amount of heat after the flow of current has been discontinued (i.e., once the heating duration has expired). The mat's retention of heat along with its position of proximity to the towel collectively ensures that if the user showers for a longer duration than the heating duration, the towel will remain warm. Thus, once the user exits the shower, the user retrieves the towel from the warming device for use in drying the user's body. Thereafter, the user may suitably permit the warming device to remain as positioned, or may suitably store the warming device in a desired location, such as in a linen closet, under a bathroom vanity, etc.

Although the invention has been described with regard to certain preferred example embodiments, it is to be understood that the present disclosure has been made by way of example only, and that improvements, changes and modifications in the details of construction and the combination and arrangement of parts may be resorted to without departing from the spirit and scope of the invention. Such improvements, changes and modifications within the skill of the art are intended to be covered by the scope of the appended claims.

1-34. (canceled)

35. A portable towel warmer designed to dry heat warm a towel comprising:
a housing having a base portion, a top portion, an inner shell, an outer shell and a lid, said inner shell having and inner surface that forms a towel cavity, said towel cavity having a bottom wall and a side wall, said towel cavity having a volume to hold up to two bath towels, said lid at least partially secured to said top portion of said housing, said lid movable between an open and a closed position wherein said lid closed position causing said one or more towels in said towel cavity to be substantially encapsulated by said towel cavity and lid and said lid open position enabling one or more towels to be inserted or removed from said towel cavity; and,
a heating system designed to dry heat one or more towels positioned in said towel cavity, said heating system including a resistive heating element, a heating controller, a current connector, and an activation switch, said resistive heating element positioned between an outer surface of said inner shell and an inner surface of said outer shell, said resistive heating element designed to dissipate heat to said towel cavity, said resistive heating element positioned at least partially about said side wall of said towel cavity, said current connector designed to connect to a current source to provide current to said resistive heating element, said heating controller terminating a flow of current to said resistive heating element once a predetermined period of time has passed since said activation switch has been actuated by a user, after a temperature sensor senses a predetermined temperature, or combinations thereof.

36. The portable towel warmer as defined in claim 35, wherein said resistive heating element includes a first electrically nonconductive layer, a second electrically nonconductive layer, and a resistance heating material disposed between said first and second electrically nonconductive layers.

37. The portable towel warmer as defined in claim 36, wherein said second electrically nonconductive layer at least partially forms said towel cavity.

38. The portable towel warmer as defined in claim 35, wherein said resistive heating element includes a reflective layer.

39. The portable towel warmer as defined in claim 36, wherein said resistive heating element includes a reflective layer.

40. The portable towel warmer as defined in claim 35, wherein said lid is rotatably connected to said top portion of said housing.

41. The portable towel warmer as defined in claim 39, wherein said lid is rotatably connected to said top portion of said housing.

42. The portable towel warmer as defined in claim 35, wherein said current connector includes an electric power cord and a wall outlet connector.

43. The portable towel warmer as defined in claim 42, wherein said electric power cord is releasably couplable to said resistive heating element.

44. The portable towel warmer as defined in claim 35, wherein said heating controller terminates a flow of current to said resistive heating element after said temperature sensor senses a predetermined temperature.

45. The portable towel warmer as defined in claim 41, wherein said heating controller terminates a flow of current to said resistive heating element after said temperature sensor senses a predetermined temperature.

46. The portable towel warmer as defined in claim 35, wherein said activation switch is positioned on an outer surface of said housing, said activation switch including a button, a sliding mechanism, or a rotary knob.

47. The portable towel warmer as defined in claim 46, wherein said activation switch is positioned on an outer surface of said housing, said activation switch including a button, a sliding mechanism, or a rotary knob.

48. The portable towel warmer as defined in claim 35, wherein said housing includes a mechanism designed to emit an active volatile substance.

49. The portable towel warmer as defined in claim 48, wherein said active volatile substance includes perfume.

50. The portable towel warmer as defined in claim 35, wherein said resistive heating element positioned substantially about the total surface of said bottom wall and said side wall of said towel cavity.

51. The portable towel warmer as defined in claim 47, wherein said resistive heating element positioned substantially about said bottom wall and said side wall of said towel cavity.

52. The portable towel warmer as defined in claim 35, wherein said heating controller includes a timer mechanism.

53. The portable towel warmer as defined in claim 52, wherein said heating controller includes an arrangement to enable a user to adjust said timer mechanism.

54. A portable textile warmer designed to dry heat warm a textile comprising:
a housing having a base portion, a top portion, an inner shell, an outer shell and a lid, said inner shell having and inner surface that forms a textile cavity, said textile cavity having a bottom wall, a first side wall and a second side wall that are spaced apart and generally parallel to one another, said textile cavity having a volume to hold up to two bath towels, said lid rotatably connected to said top portion of said housing, said lid movable between an open and a closed position wherein said lid closed position causing said one or more textiles in said textile cavity to be substantially encapsulated by said textile cavity and lid and said lid open position enabling one or more textiles to be inserted or removed from said textile cavity; and,
a heating system designed to dry heat one or more textiles positioned in said textile cavity, said heating system including a resistive heating element, a heating controller, a current connector, and an activation switch, said resistive heating element positioned between an outer surface of said inner shell and an inner surface of said outer shell, resistive heating element spaced from said inner surface of said outer shell, said resistive heating element designed to dissipate heat to said textile cavity, said resistive heating element including a first electrically nonconductive layer, a second electrically nonconductive layer, and a resistance heating material disposed between said first and second electrically nonconductive layers, said resistive heating element positioned substantially about the total surface of said first and second side walls of said textile cavity, said current connector designed to connect to a current source to provide current to said resistive heating element, said heating controller terminating a flow of current to said resistive heating element after a temperature sensor senses a predetermined temperature.

55. The portable textile warmer as defined in claim 54, wherein said bottom wall of said cavity having an arcuate shape.

56. The portable textile warmer as defined in claim 54, wherein said resistive heating element positioned substantially about the total surface of said bottom wall of said textile cavity.

57. The portable textile warmer as defined in claim 54, wherein said second electrically nonconductive layer at least partially forms said textile cavity.

58. The portable textile warmer as defined in claim 54, wherein said resistive heating element includes a reflective layer.

59. The portable textile warmer as defined in claim 54, wherein said current connector includes an electric power cord and a wall outlet connector.

60. The portable textile warmer as defined in claim 59, wherein said housing includes a spool mechanism for at least a portion of the electric power cord.

61. The portable textile warmer as defined in claim 54, wherein said activation switch is positioned on an outer surface of said housing, said activation switch including a button, a sliding mechanism, or a rotary knob.

62. The portable textile warmer as defined in claim 54, wherein said housing includes a mechanism designed to emit an active volatile substance.

63. The portable textile warmer as defined in claim 54, wherein said heating system includes a visual indicator on an outer surface of said housing to indicate that current is flowing through said resistive heating element, said resistive heating element is in a cool down mode, or combinations thereof.

64. The portable textile warmer as defined in claim 54, wherein said heating system includes a programmable interface designed to receive user-generated instructions for activation heating system at a predetermined period of time.

65. The portable textile warmer as defined in claim 54, wherein said heating system includes a safety circuit breaker.

66. The portable textile warmer as defined in claim 54, wherein said housing includes a handle to enable a user to conveniently transport said housing.

67. The portable textile warmer as defined in claim 54, wherein said lid includes a handle to enable a user to conveniently open and close said lid.

68. The portable textile warmer as defined in claim 54, wherein said lid includes a securing arrangement to maintain said lid in said closed position.

69. The portable textile warmer as defined in claim 54, wherein said textile includes a towel.

70. The portable textile warmer as defined in claim 54, wherein said housing includes at least one connector designed to secure said housing to a wall.
